(19) United States
(12) Patent Application Publication
(10) Pub. No.: US 2024/0335349 A1
(43) Pub. Date: Oct. 10, 2024

(54) MASSAGE FOAM ROLLER SLEEVE AND ASSOCIATED METHODS

(71) Applicant: Josh Montanye, Bozeman, MT (US)

(72) Inventor: Josh Montanye, Bozeman, MT (US)

(21) Appl. No.: 18/295,602

(22) Filed: Apr. 4, 2023

(51) Int. Cl. A61H 15/00

(52) U.S. Cl. CPC A61H 15/0092; A61H 2015/0014; A61H 2201/0157

(57) ABSTRACT

The therapeutic massage roller sleeve can fit onto a cylindrical beverage container. The sleeve is made of a substrate material and a layer of resilient material that has a pattern of protuberances defining a therapeutic roller surface. The sleeve can be collapsible and may have an open end and a closed end opposite to it. A longitudinal slit may be present in the sleeve from the open end towards the closed end, and a fastening device such as a zip fastener or a hook-and-loop fastener can selectively close it when the sleeve is fit onto the cylindrical beverage container. The substrate material can be stretchable and made of neoprene. The protuberances may include ridges and/or knobs.

### FIELD

The present invention relates in general to the field of massage rollers, and particularly to a collapsible sleeve to fit around a cylindrical beverage container with an exterior covered with compressed foam ridges.

### BACKGROUND

Foam rollers are cylindrical foam devices used for self-massage and myofascial release. They are commonly used by athletes, fitness enthusiasts, and physical therapists to improve muscle flexibility and alleviate muscle soreness. Foam rollers come in a variety of shapes and sizes, with different densities and textures, and can be used for different parts of the body.

The idea behind foam rollers is to apply pressure to trigger points or knots in the muscles, which can reduce muscle tension, increase blood flow, and improve range of motion. Myofascial release is the process of applying pressure to these trigger points to release the tension in the muscle and fascia, the connective tissue surrounding the muscle. This can help improve muscle function and prevent injuries.

Foam rollers have been used in physical therapy and rehabilitation for decades, but have gained popularity in recent years as a tool for fitness enthusiasts and athletes. The use of foam rollers has become increasingly common in sports such as running, cycling, and weightlifting, where muscle soreness and tightness are common issues.

There are several different types of foam rollers available, including low-density, high-density, and textured rollers. Low-density foam rollers are softer and provide a gentler massage, while high-density rollers are firmer and provide a deeper massage. Textured rollers have bumps or ridges on the surface, which can provide a more targeted massage.

Foam rollers are commonly used for the back, legs, and arms, but can also be used for the feet, neck, and shoulders. They can be used before or after a workout, or as part of a warm-up or cool-down routine. Some people also use foam rollers as a form of relaxation or stress relief.

Current products in this field lack mobility to be conveniently portable or to be utilized in the location of sporting and recreation activities. If traveling with limited space for personal belongings (i.e. airline luggage or remote backpacking), packing a traditional foam roller may not be practical. There are a few collapsible foam rollers on the market, such as the RitFit and/or the Brazyn Morph, but they are not collapsible sleeves and not designed to fit over a sturdy object or frame, such as a beverage container.

This background information is provided to reveal information believed by the applicant to be of possible relevance to the present invention. No admission is necessarily intended, nor should be construed, that any of the preceding information constitutes prior art against the present invention.

### SUMMARY OF THE EMBODIMENTS

The invention is a therapeutic massage roller sleeve that can fit onto a cylindrical beverage container. The sleeve is made of a substrate material and a layer of resilient material that has a pattern of protuberances defining a therapeutic roller surface. The sleeve can be collapsible and may have an open end and a closed end opposite to it. A longitudinal slit may be present in the sleeve from the open end towards the closed end, and a fastening device such as a zip fastener or a hook-and-loop fastener can selectively close it when the sleeve is fit onto the cylindrical beverage container. The substrate material can be stretchable and made of neoprene. The method of making the sleeve involves forming a substrate material as a sleeve to hold and fit onto a cylindrical beverage container and affixing a layer of resilient material to the substrate material, which comprises a pattern of protuberances defining a therapeutic roller surface. The protuberances may include ridges and/or knobs.

### BRIEF DESCRIPTION OF THE DRAWINGS

The example embodiments are best understood from the following detailed description when read with the accompanying drawing figures. In fact, the dimensions may be arbitrarily increased or decreased for clarity of discussion. Wherever applicable and practical, like reference numerals refer to like elements.

FIG. 1 is a side view illustrating an example embodiment of a therapeutic massage roller sleeve installed on a beverage container in accordance with features of the present invention.

FIG. 2 is a top perspective view illustrating details of the therapeutic massage roller sleeve of FIG. 1.

FIG. 3 is another top perspective view illustrating details of the therapeutic massage roller sleeve of FIG. 1.

FIG. 4 is a side perspective view illustrating details of the therapeutic massage roller sleeve of FIG. 1 while removed from the beverage container.

FIG. 5 is a top view illustrating details of the therapeutic massage roller sleeve of FIG. 1 while removed from the beverage container.

FIG. 6 is a top view illustrating details of the therapeutic massage roller sleeve of FIG. 1 while removed from the beverage container and in a collapsed state.

FIG. 7 is a bottom view illustrating details of the therapeutic massage roller sleeve of FIG. 1 while removed from the beverage container and in a collapsed state.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An object of the present invention may be to provide a lightweight, collapsible sleeve (or cover, jacket, sheath, wrapper etc.) made of neoprene or another fabric designed to fit around a cylindrical beverage container with an exterior covered with compressed foam ridges. This invention allows individuals to conveniently use a foam roller in any location where they have a structurally sound beverage container such as a metal or Nalgene water bottle. This invention utilizes a user's rigid beverage container as the internal core of the foam roller, therefore with no structural frame elements, the product is lightweight and collapsible. It can be transported in a small bag or around the beverage container. The exterior of the sleeve will be patterned with ridges or nodules of compressed foam.

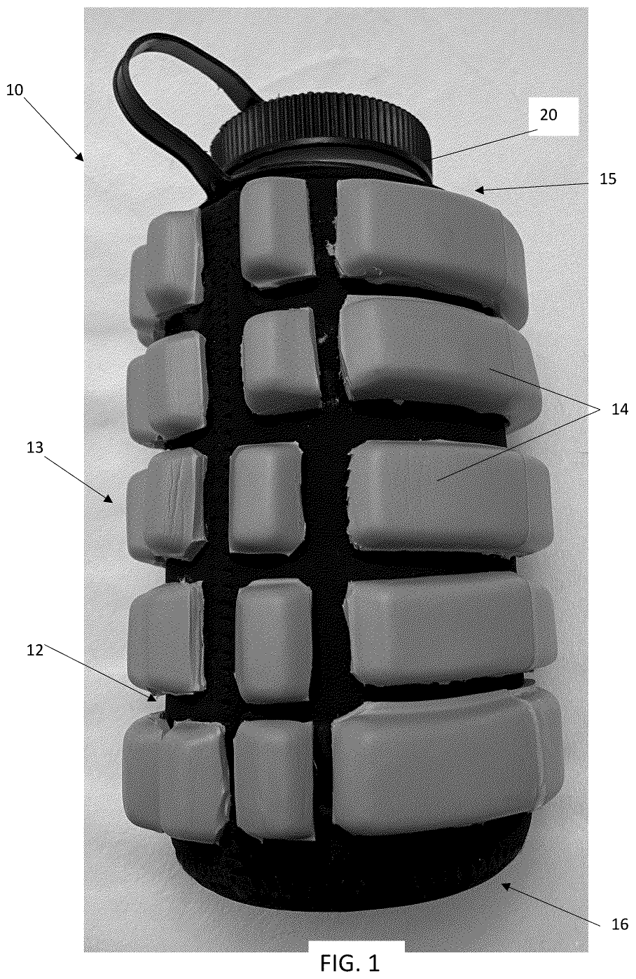

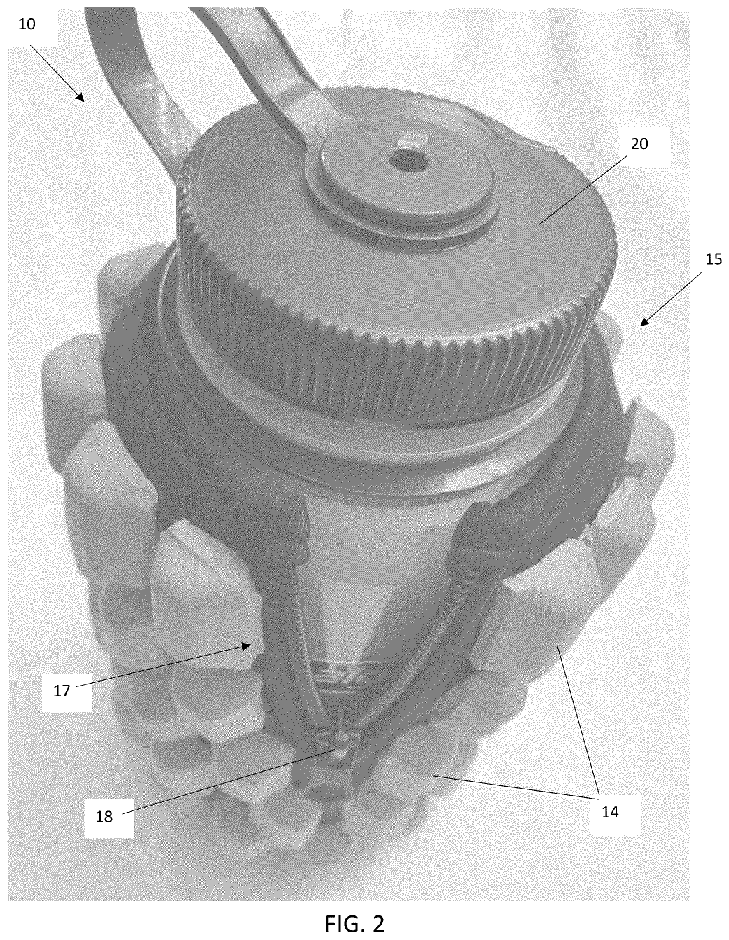

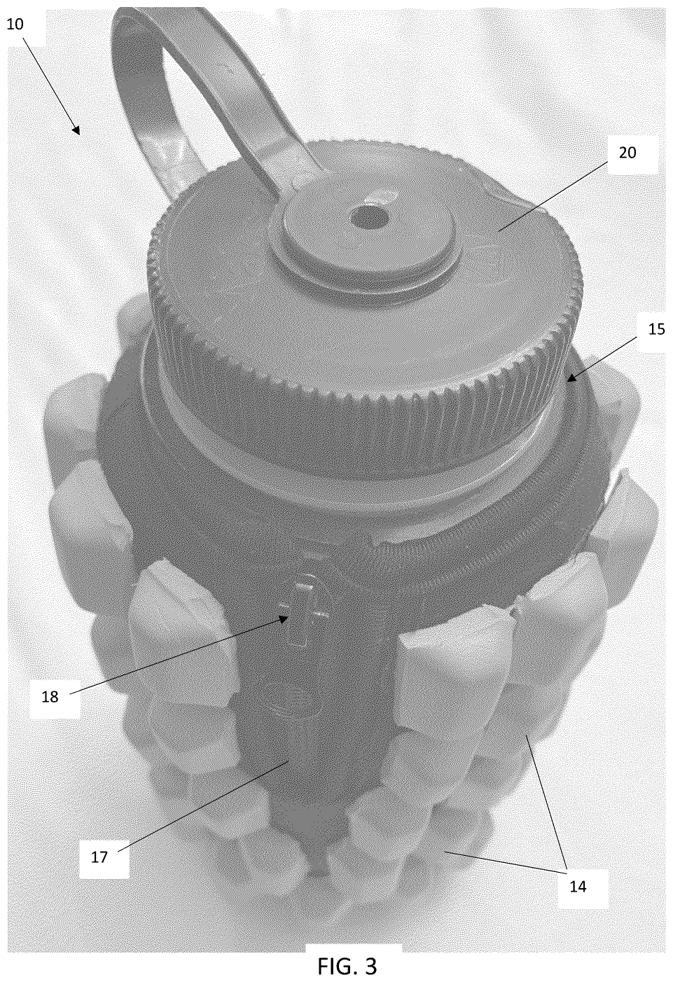

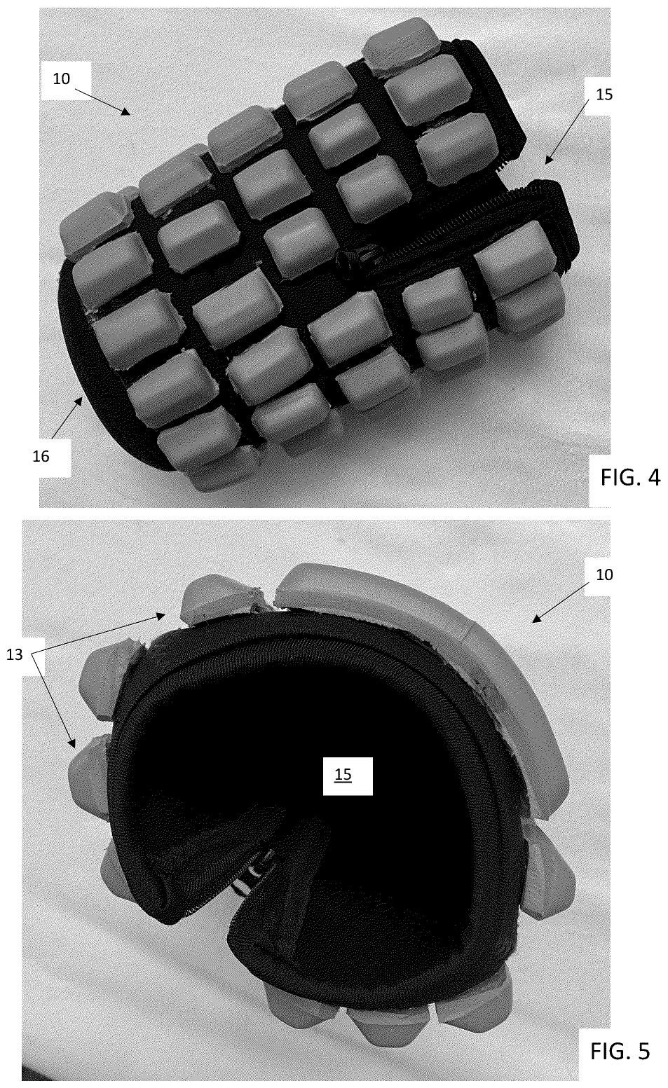

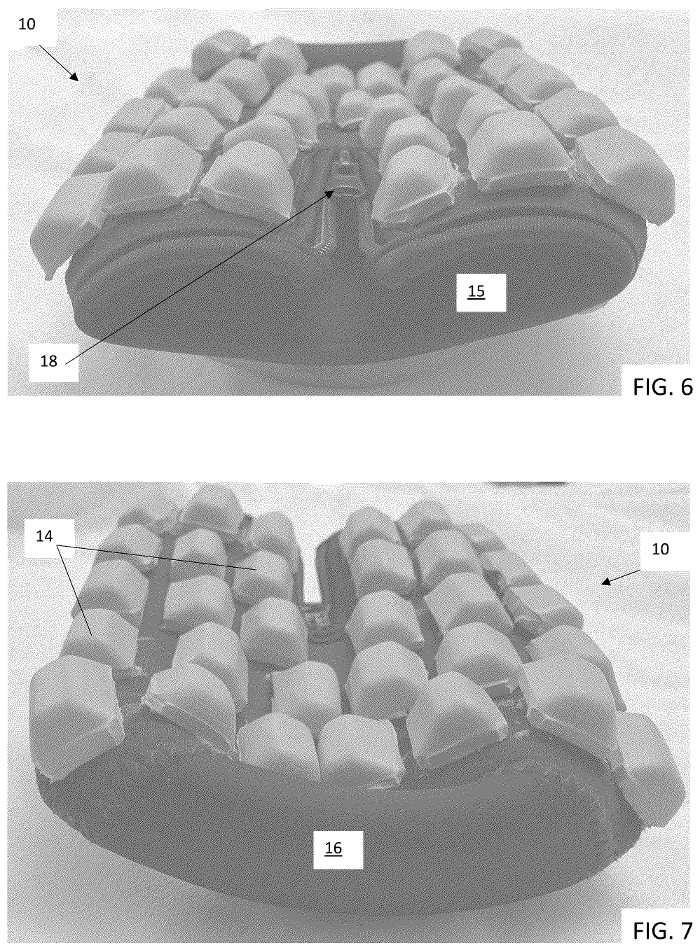

FIGS. 1-7 illustrate an example embodiment of a therapeutic massage roller sleeve 10 that can fit onto a cylindrical beverage container 20. As an example, cylindrical beverage container 20 is typically around 3-5″ in diameter and 7-10″ tall. Other sizes of beverage containers and corresponding sleeves are also contemplated.

The sleeve 10 is made of a substrate material 12 and a layer of resilient material 13 that has a pattern of protuberances 14 defining a therapeutic roller surface 19. The sleeve 10 can be collapsible and may have an open end 15 and a closed end 16 opposite to it. A longitudinal slit 17 may be present in the sleeve from the open end 15 towards the closed end 16. A fastening device 18 such as a zip fastener or a hook-and-loop fastener can selectively close the slit 17 when the sleeve 10 is fit onto the cylindrical beverage container 20. The substrate material 12 can be stretchable and, for example, made of neoprene. Other suitable materials are contemplated.

A method of making the sleeve 10 involves forming the substrate material 12 as a sleeve to hold and fit onto a cylindrical beverage container 20 and affixing a layer of resilient material 13 to the substrate material 12, which comprises a pattern of protuberances 14 defining a therapeutic roller surface 19. The protuberances 14 may include ridges and/or knobs, as discussed. Such protuberances 14 may be individually affixed to the substrate material 12 or they may be formed as an integrated layer of protuberances 14 and then affixed to the substrate material 12.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

1. A therapeutic massage roller sleeve comprising:
a substrate material configured as a sleeve to hold and fit onto a cylindrical beverage container; and
a layer of resilient material affixed to the substrate material and comprising a pattern of protuberances defining a therapeutic roller surface.

2. The therapeutic massage roller sleeve according to claim 1, wherein the sleeve is a collapsible sleeve.

3. The therapeutic massage roller sleeve according to claim 1, wherein the sleeve includes an open end and a closed end opposite the open end.

4. The therapeutic massage roller sleeve according to claim 3, wherein the sleeve further includes a longitudinal slit therein extending from the open end towards the closed end.

5. The therapeutic massage roller sleeve according to claim 4, wherein the sleeve further includes a fastening device to selectively close the longitudinal slit when the sleeve is fit onto the cylindrical beverage container.

6. The therapeutic massage roller sleeve according to claim 5, wherein the fastening device comprises at least one of a zip fastener or a hook-and-loop fastener.

7. The therapeutic massage roller sleeve according to claim 1, wherein the substrate material comprises a stretchable material.

8. The therapeutic massage roller sleeve according to claim 7, wherein the stretchable material comprises neoprene.

9. The therapeutic massage roller sleeve according to claim 1, wherein the protuberances comprise at least ridges and/or knobs.

10. A method of making a therapeutic massage roller sleeve, the method comprising:
forming a substrate material as a sleeve to hold and fit onto a cylindrical beverage container; and
affixing a layer of resilient material to the substrate material, the layer of resilient material comprising a pattern of protuberances defining a therapeutic roller surface.

11. The method according to claim 10, wherein the sleeve is a collapsible sleeve.

12. The method according to claim 10, wherein the sleeve includes an open end and a closed end opposite the open end.

13. The method according to claim 12, wherein forming the sleeve further includes forming a longitudinal slit therein extending from the open end towards the closed end.

14. The method according to claim 13, wherein forming the sleeve further includes providing a fastening device to selectively close the longitudinal slit when the sleeve is fit onto the cylindrical beverage container.

15. The method according to claim 14, wherein the fastening device comprises at least one of a zip fastener or a hook-and-loop fastener.

16. The method according to claim 10, wherein the substrate material comprises a stretchable material.

17. The method according to claim 16, wherein the stretchable material comprises neoprene.

18. The method according to claim 10, wherein the protuberances comprise at least ridges and/or knobs.
